(19) United States
(12) Patent Application Publication
(10) Pub. No.: US 2008/0196248 A1
(43) Pub. Date: Aug. 21, 2008

(54) Method for Producing an Exhaust-Carrying Device

(76) Inventors: Erich Forster, Grossailtingen (DE); Peter Kroner, Zweibrucken (DE); Stefan Schmidt, Langweld (DE)

Correspondence Address: PAMELA A. KACHUR, 950 W 450 S, BLDG. 4, COLUMBUS, IN, 47201, US

(21) Appl. No.: 11/813,931

(22) PCT Filed: Jan. 17, 2006
(86) PCT No.: PCT/EP2006/000371

§ 371 Date: Mar. 6, 2008

(30) Foreign Application Priority Data
Jan. 17, 2005 (DE) 10 2005 002 165.4

(51) Int. Cl. B23P 11/00

(52) U.S. Cl. 29/890.08; 72/367.1; 100/42

(57) ABSTRACT

A method of producing an exhaust gas-carrying device in which the gas-carrying device includes at least one insert piece and a cylindrical outer housing is disclosed. The method includes the steps of introducing the insert piece into the outer housing and applying radial forces with clamping jaws which bear against the outer surface area of the outer housing and plastically deform the outer housing inwards in order to clamp the insert piece in the outer housing. The clamping jaws are configured to have edges such that marking lines are formed in the outer housing which do not continuously extend axially parallel to the outer housing along that portion of the outer housing in which the insert piece is arranged.

The invention relates to a method of producing an exhaust gas-carrying device, comprising at least one insert piece and a cylindrical outer housing, which method comprises the following steps: Introducing the insert piece into the outer housing and applying radial forces by means of clamping jaws which bear against the outer surface area of the outer housing and plastically deform the outer housing inwards in order to clamp the insert piece in the outer housing. Moreover, the invention relates to an exhaust gas-carrying device comprising at least one insert piece and a plastically deformed cylindrical outer housing.

Such a method and an exhaust gas carrying device of this type are known from prior art (see for instance EP 0 982 480 A2), with the exhaust gas-carrying device being a catalytic converter, a particle filter for diesel engines or a muffler of a motor vehicle, for example.

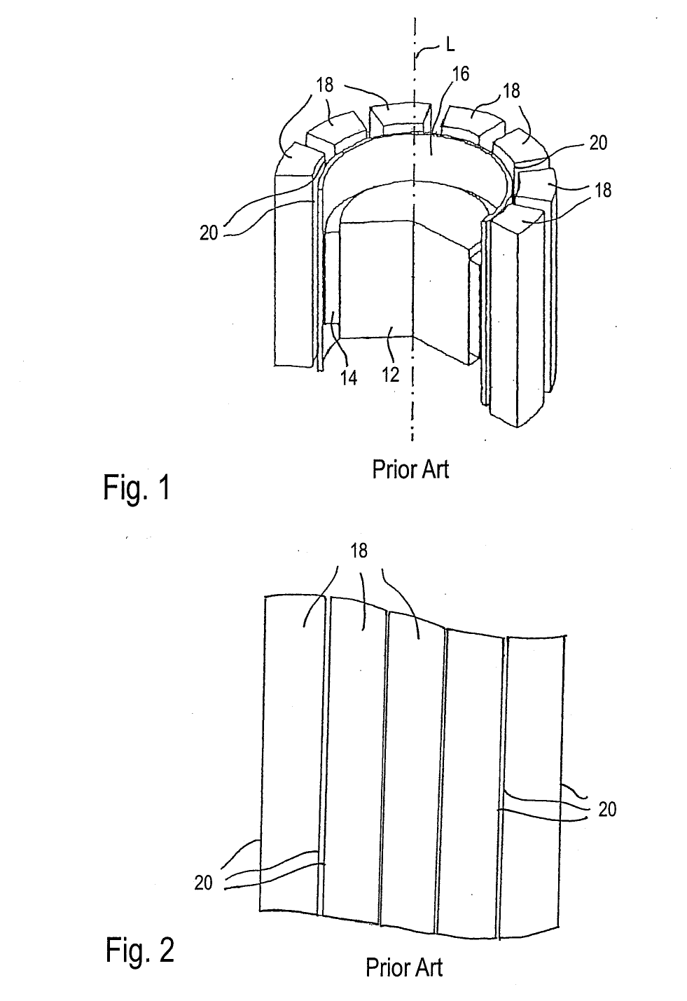

FIG. 1 shows a tool which is usually used for clamping an insert piece, which in the case of a vehicular catalytic converter 10 is formed by a ceramic substrate 12 and an insulation mat 14, for instance, in an outer housing 16. The tool has several clamping jaws 18 which are arranged around the substrate 12, the insulation mat 14 and the outer housing 16. Subsequently the clamping jaws 18 are pressed radially inwards toward the outer housing 16, whereby radial forces act on the outer surface area of the outer housing 16. Thereby the outer housing 16 is plastically deformed in inward direction and, hence, the substrate 12 and the insulation mat 14 will be clamped in the outer housing 16. The clamping jaws 18 have the shape of a hollow cylinder when completely brought together, the inner diameter of which just equaling the desired outer diameter of the finished catalytic converter 10.

A disadvantage of the described method of producing an exhaust gas-carrying device is that the process of moving the clamping jaws 18 towards each other results in marking lines in the outer housing 16, which marking lines are nearby the contact surfaces of the inner longitudinal edges 20 of the clamping jaws 18 with the outer housing 16 and are formed by the outer housing 16 being impressed in sections. These inner longitudinal edges 20 extend rectilinearly with the clamping jaws 18 according to prior art and parallel to the longitudinal axis L of the outer housing 16, as can be seen particularly well in FIG. 2, showing the developed inner lateral surface of the tool according to prior art.

During the deformation process it may happen that indentations—also referred to as dents—develop on a portion of the outer housing 16. This risk exists in particular with outer housings which do not have a circular cross-section, but an elliptical or an approximately triangular cross-section, for example.

Therefore, it is the object of the invention to provide a method of the type initially mentioned by means of which an exhaust gas-carrying device can be produced, the outer housing of which has a higher stability during deformation.

According to the invention, provision is made in a method of the type initially mentioned in that the clamping jaws are configured such and have edges such that marking lines are formed in the outer housing which do not continuously extend axially parallel to the outer housing along that portion of the outer housing in which the insert piece is arranged. It is by the method according to the invention that an exhaust gas-carrying device of the type initially mentioned is produced in which the outer housing has marking lines which do not continuously extend axially parallel to the outer housing along that portion of the outer housing in which the insert piece is arranged. Thus, the resulting marking lines have one or more portions which do not extend axially parallel to the outer housing, which also means that they comprise several portions which, when seen singularly, are axially parallel but offset relative to each other. In any case, the marking lines are not both continuous and continuously axially parallel, whereby the susceptibility of the outer housing in terms of indentations and dents is remarkably reduced.

By the special orientation of the marking lines the forces applied to the housing during deformation are transmitted into and distributed in the outer housing more uniformly. The method according to the invention is distinguished by a very simple and low-cost applicability, because in the method according to prior art ideally only the clamping jaws 18 have to be replaced, while the remaining production equipment can be maintained.

According to a preferred embodiment the marking lines have at least one portion which extends obliquely relative to the longitudinal axis of the outer housing, whereby the outer housing has an enhanced stability during deforming.

The marking lines preferably have at least one axially parallel portion and at least one portion which extends transverse to the longitudinal axis of the outer housing, and are brought about by clamping jaws which can be manufactured in a comparable simple manner.

According to a further embodiment several axially consecutively arranged groups of marking lines, extending across partial lengths, are formed in the outer housing, with the marking lines of subsequent groups being offset relative to each other in circumferential direction. This is achieved, for instance, by the employment of clamping jaws comprising several sections which are arranged axially in succession and in each case exhibit longitudinal edges which are axially parallel to the outer housing, every two consecutive sections being arranged so as to be offset from one another. Clamping jaws configured in such a manner are distinguished by a particularly simple and low-cost producibility.

It will be preferred that the opposite longitudinal edges of each of the clamping jaws extend parallel to each other; advantageously, all clamping jaws have identical geometries and dimensions. This will result in a set of clamping jaws which can be interchanged at will, whereby it is possible without difficulty to keep spare parts in stock, for instance.

Further features and advantages of the invention will be apparent from the following specification of several preferred embodiments on the basis of the attached drawing in which:

FIG. 1 is a perspective view of a tool for producing an exhaust gas-carrying device according to prior art, partially in cross-section;

FIG. 2 is a top view of the developed inner lateral surface of the prior art tool according to FIG. 1;

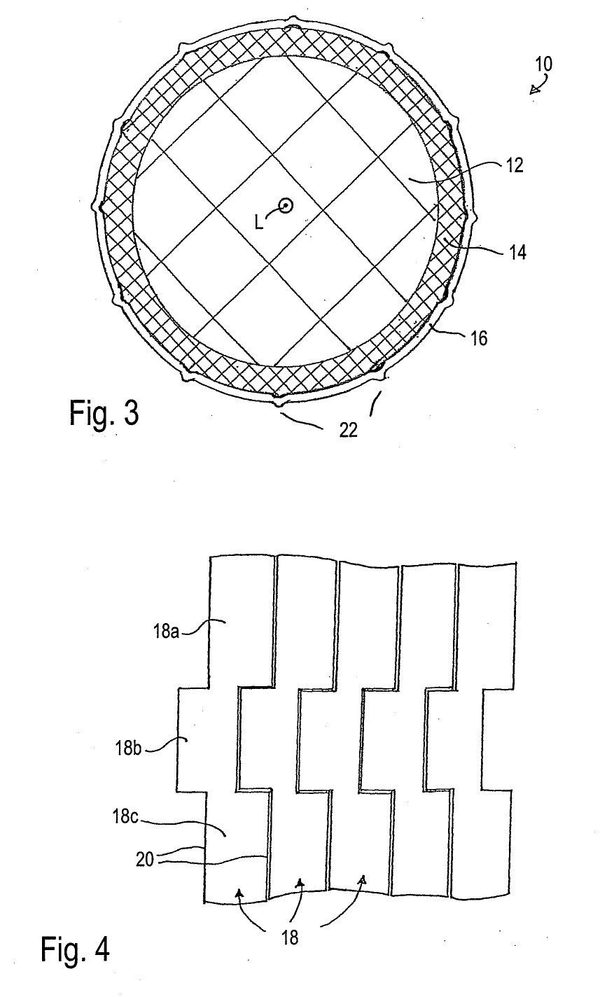

FIG. 3 is a sectional view taken through an exhaust gas-carrying device produced by the method according to the invention;

FIG. 4 is a top view of the developed inner lateral surface of a tool for performing the method according to the invention, which also corresponds to the top view of a developed outer housing; and

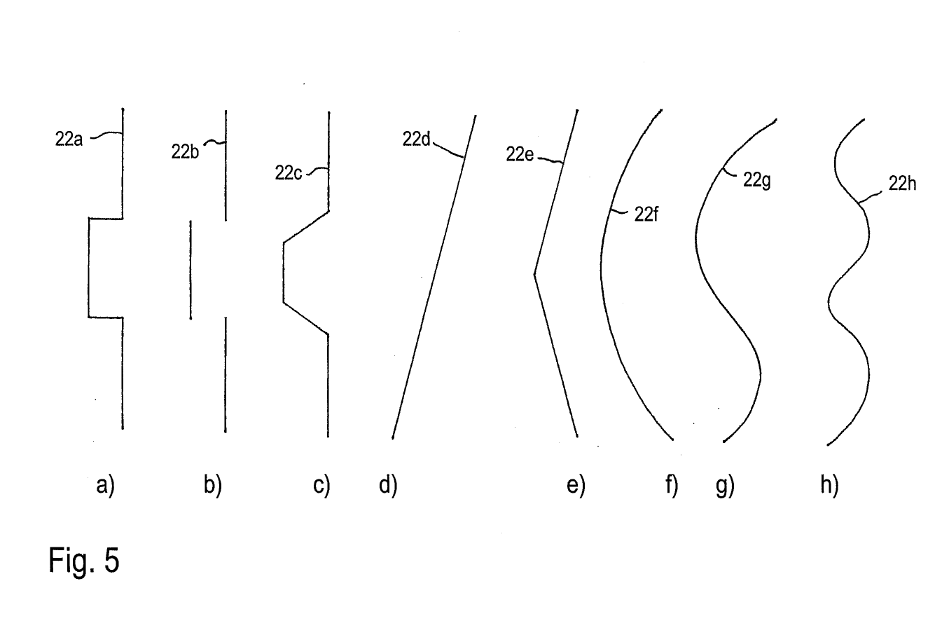

FIGS. 5a to 5h are schematic views of various embodiments of marking lines which are formed in the outer housing of the exhaust gas-carrying device during performing the method according to the invention.

FIG. 3 shows a sectional view through an exhaust gas-carrying device in the form of a catalytic converter 10 which has been produced by means of the method according to the invention. Here too, the outer housing 16 of the catalytic converter 10 has several marking lines 22, as is known from prior art, which are formed in that the outer housing 16 is deformed in inward direction only in the region of the clamping jaws 18 and not between the opposite longitudinal edges 20 of adjacent clamping jaws 18. The marking lines 22 which protrude outwards, however, do not continuously extend axially parallel to the outer housing 16, whereby the outer housing 16 during deforming exhibits a lower susceptibility with respect to indentations and dents.

A possible tool for clamping the ceramic substrate 12 and the insulation mat 14 in the outer housing 16 is illustrated in FIG. 4. Again, the tool is a hollow cylinder made up of several clamping jaws 18, but compared with prior art (see FIG. 2) the longitudinal edges 20 with the clamping jaws 18 according to the invention do not continuously extend axially parallel to the outer housing 16. According to the embodiment of the invention shown in FIG. 4, the clamping jaws 18 have an upper portion 18a, a middle portion 18b and a lower portion 18c, with the middle portion 18b of each clamping jaw being offset to the left with respect to the upper portion 18a and the lower portion 18c by roughly half the width of a clamping jaw.

The opposite longitudinal edges 20 of each clamping jaw 18 extend parallel to each other along the entire length of the clamping jaw 18, and the geometry and the dimensions are the same for all clamping jaws 18, i.e. they mate with each other seamlessly in the closed state.

If one employs the clamping jaws 18, which are illustrated in FIG. 4, in the production of an exhaust gas-carrying device, then several bead-like marking lines 22a will be formed in its outer housing 16 which are arranged parallel to each other and extend in the nature of crenellates along the longitudinal axis L of the outer housing 16, essentially having the shape illustrated in FIG. 5a.

Apart from the one-piece form of the individual clamping jaws 18 which is illustrated in FIG. 4, it is likewise conceivable, of course, that each individual clamping jaw 18 consists of three separate portions 18a, 18b and 18c, which are arranged so as to be offset in circumferential direction of the outer housing 16. With the employment of clamping jaws which are configured in such a manner, several axially consecutively arranged groups of marking lines are formed which extend across partial lengths, with the marking lines of consecutive groups being offset from one another in circumferential direction (FIG. 5b).

Of course, the clamping jaws 18 may have any other configuration which results in the formation of marking lines 22 which do not continuously extend axially parallel to the outer housing 16; some further examples of these are shown in FIGS. 5c to 5h. Here too, the shape of the respective longitudinal edges 20 of the clamping jaws 18 corresponds to the shape of the developing marking lines.

Thus, marking lines 22c are conceivable which have several axially parallel portions and several portions which extend obliquely relative to the longitudinal axis L of the outer housing. It is likewise possible to give the clamping jaws 18 such a design that marking lines are formed which continuously extend obliquely relative to the longitudinal axis L of the outer housing. In this arrangement, the marking lines may be diagonal marking lines 22d or angle-forming marking lines 22e.

Besides, FIGS. 5f to 5h show bow-shaped, approximately S-shaped and meander-like marking lines 22f to 22h.

It is common to all possible marking lines 22a to 22h, which have been shown, that they do not continuously extend axially parallel to the outer housing of the exhaust gas-carrying device.

1.-11. (canceled)

12. A method of producing an exhaust gas-carrying device, comprising at least one insert piece and a cylindrical outer housing, the method comprising the following steps:
introducing the insert piece into the outer housing, and
applying radial forces with clamping jaws which bear against the outer surface area of the outer housing and plastically deform the outer housing inwards in order to clamp the insert piece in the outer housing,
wherein the clamping jaws have edges that are configured to form marking lines in the outer housing which do not continuously extend axially parallel to the outer housing along that portion of the outer housing in which the insert piece is arranged.

13. The method of claim 12, wherein the marking lines have at least one portion which extends obliquely relative to the longitudinal axis of the outer housing.

14. The method of claim 12, wherein the marking lines have at least one axially parallel portion and at least one portion which extends transverse to the longitudinal axis of the outer housing.

15. The method of claim 12, wherein the marking lines extend along the longitudinal axis in the nature of crenellates.

16. The method of claim 12, wherein the marking lines extend in a bow shape with respect to the longitudinal axis.

17. The method of claim 12, wherein the marking lines extend approximately in a S-shape.

18. The method of claim 12, wherein the marking lines extend in the form of a meander.

19. The method of claim 12, wherein several axially consecutively arranged groups of marking lines, extending across partial lengths, are formed in the outer housing, with the marking lines of subsequent groups being offset relative to each other in circumferential direction.

20. The method of claim 12, wherein the opposite longitudinal edges of each of the clamping jaws extend parallel to each other.

21. The method of claim 12, wherein all the clamping jaws have identical geometries and dimensions.

22. An exhaust gas-carrying device, comprising:
at least one insert piece, and
a plastically deformed cylindrical outer housing, wherein the outer housing has marking lines which do not continuously extend axially parallel to the outer housing along that portion of the outer housing in which the insert piece is arranged.
